(19) United States
(12) Patent Application Publication
(10) Pub. No.: US 2003/0131080 A1
(43) Pub. Date: Jul. 10, 2003

(54) Method for updating a database

(76) Inventors: Stefan Bayer, Zirndorf (DE); Hendrik Schade, Erlangen (DE); Theresia Lainer, Seligenporten (DE)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/316,922

(22) Filed: Dec. 12, 2002

(30) Foreign Application Priority Data
Dec. 20, 2001 (DE) 10163009.3

(51) Int. Cl. G06F 15/177; G06F 17/30

(52) U.S. Cl. 709/220; 707/10

(57) ABSTRACT

The present invention concerns a method for updating a database in which data about a software and/or hardware configuration of a device of a network is stored. According to the invention, the device receives a current inquiry, transmitted from the database, about the current software and/or hardware configuration of the device. Then the device determines its current software and/or hardware configuration, verifies if its current software and/or hardware configuration has been modified since an earlier inquiry, transmitted from the database, and transmits data about its current software and/or hardware configuration to the database, if its software and/or hardware configuration was modified.

### CROSS REFERENCE TO RELATED APPLICATIONS

The present application claims priority to German patent application DE 10163009.3, filed Dec. 20, 2001, which is herein incorporated by reference.

### BACKGROUND OF THE INVENTION

The present invention relates to the field of database management and more particularly to a method for updating a database wherein data regarding software and/or hardware configuration of a device in a network is stored.

Firms generally maintain one or more databases wherein data about software and/or hardware configurations are stored in devices which are operated and were otherwise delivered or installed by the firm. If the precise software and/or hardware configuration of the device was insufficiently documented, particularly at delivery or installation of the device, the stored data of the database, and in particular the databases, are incorrect. A subsequent acquisition of the software and/or hardware configurations of inadequately acquired devices is time consuming, expensive and sometimes nearly impossible.

A system and method for monitoring a configuration of a computer which is connected to a computer network is set out in U.S. Pat. No. 5,758,071. Herein, the computer repeatedly detects its configuration and transmits the configuration data to another computer, also connected to the computer network, which stores the configuration data in a database.

### BRIEF SUMMARY OF THE INVENTION

An advantage of the present invention is directed to a method for the simplified updating of a database, in which an indication regarding a software and/or hardware configuration of a device of a network is stored. This and related advantages are achieved by a method for updating a database in which data about a configuration of at least one device of a network is stored, comprising the steps of: transmitting from a database to said device an inquiry regarding a current device configuration; determining at said device said current device configuration; verifying at said device if said current configuration was modified since an earlier transmitted inquiry from said database; and if said configuration has been modified, transmitting said current configuration to said database.

The device, which is part of a network, receives, according to the invention, the current inquiry for its current software and/or hardware configuration from the database. Because the device has the data available, if its software and/or hardware configuration has been modified since the earlier inquiry, it is possible, according to the invention, to then only transmit the data about the current software and/or hardware configuration to the database, again, if the software and/or hardware configuration was modified. Consequently, the database receives a message from the device only if there is no image of the current software and/or hardware configuration in the database. It is therefore assured that the database includes the current data about the software and/or hardware configuration of the device after the current inquiry. If the software and/or hardware configuration of the device was not modified since the prior inquiry, it is unnecessary to communicate the current software and/or hardware configuration to the database, because the database already has this data. In essence, no messages are transmitted to the database comprising data already known to the database. The database or network, among others involved with a message transmission, are therefore not unnecessarily overloaded.

The device produces a first list, based on the earlier inquiries according to one embodiment of the present method, which includes data about the then current software and/or hardware configuration of the device. Additionally, the device produces a second list, based on the current inquiry, which includes data about the current software and/or hardware configuration of the device. Furthermore, the device compares, based on the current inquiry, the data about the software and/or hardware configurations of both lists and transmits the second list to the database, if the data about the software and/or hardware configurations of both lists, differ.

To update the database regularly, it is according to an embodiment of the present invention, that the device regularly receives the current inquiry from the database. The method can be carried out in an advantageous way, if it is, as according to a further design of the present invention, executed with a network management system. Network management systems are for example described in V. M. Swisher et al., mastering network management, Numidia Press, Fremont, 1996. Known network management systems are for example the HP OpenView, the IBM NetView or the Novel NetWare.

The current system and program values of the respective devices of the network are always available to the user based on the present inventive method. These can be particularly used for reporting purposes, for example determination of all systems which require an update. If the user already uses a network management system, the inventive method can be incorporated in a particularly easy way by the network management system. Should the software and/or hardware configuration of the device be modified in-situ, this can be determined centrally in a simple way at any time, by which the database is updated in a simple way.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a network,

FIG. 2 depicts a list prepared by an agent, and

FIG. 3 depicts a screen shot or mask of a network management station.

### DETAILED DESCRIPTION OF THE INVENTION

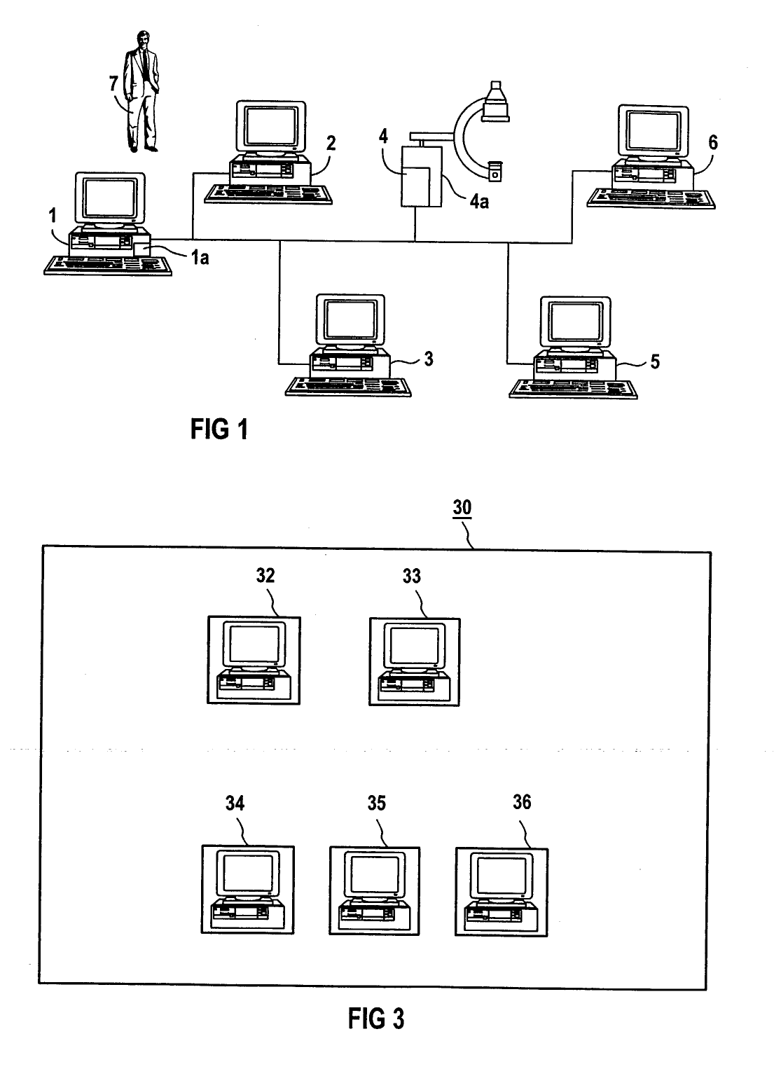

FIG. 1 depicts an example of a network, which includes several computers labeled 1-6. In the depicted embodiment, the network is observed with an agent manager network management system. One of the computers of the network is a so-called network management station (NMS) 1 and the computer 4 controls an x-ray device 4a, by way of example. A manager is stored on the NMS1 communicates with the agents stored on computers 2-6. The manager is an appropriately executed computing program and can send inquiries to the agents and receive messages from the agents based on the inquiries. An agent is also a computing program which is executed in such a way that it monitors the computer on which it is stored, receives sent out inquiries from the manager of the NMS1, and answers them accordingly.

In the depicted embodiment, the software and hardware configuration of the computers 2-6 is further imaged on a database of the NMS1. For this image to be as current as possible, according to an embodiment, the manager of the NMS1 automatically and daily transmits an inquiry to the agents of the computers 2 to 6, with which the manager inquires the current software and hardware configuration of the computers 2-6.

After the agent, of for example computer 2, receives the inquiry of the manager, it generates, in the case of the present example of execution, a list which includes the current software and hardware configuration of the computer 2. Afterwards, the agent compares this list with a list which the agent had produced the previous day based on a prior inquiry of the manager. The list produced the day before includes a data about the software and hardware configuration of the computer 2 at the time of the inquiry of the previous day.

If the result of the comparison of both lists is that neither the software configuration nor the hardware configuration of the computer 2 has changed, then the current software and hardware configuration of the computer 2 is stored in the database of NMS1. The agent of the computer 2 therefore does not send the produced current list to the manager of the NMS1. Additionally, the agent of the computer 2 stores the produced current list in a memory assigned to the agent and deletes the produced list from the previous day after comparing both lists.

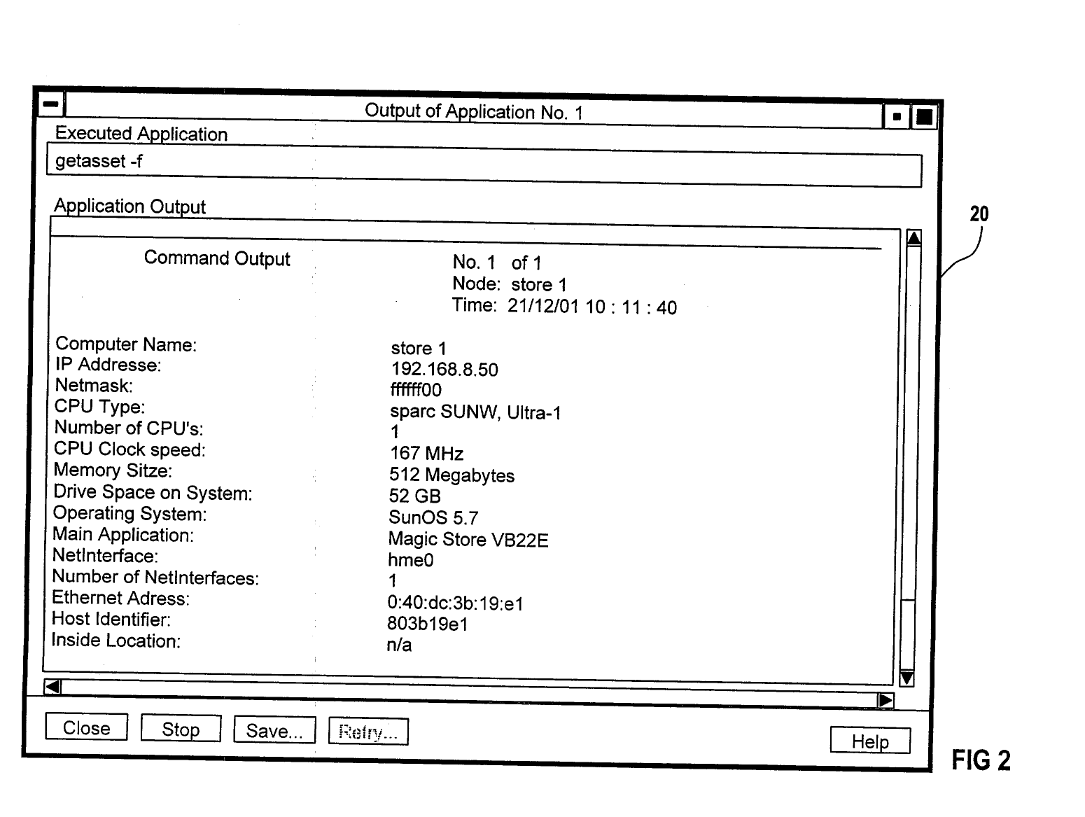

In an example embodiment, on computer 2 a new hard disk 2a was installed into the computer 2 after the inquiry of the manager of NMS1 from the previous day. The hardware configuration of the computer 2 has therefore changed since the inquiry from the previous day. The data of the lists 20 (FIG. 2), updated by the agent of the computer 2, differ therefore from the data which was produced the previous day. The agent of the computer 2 therefore sends the current list to the manger of the NMS1 so that the image of the software and hardware configuration of the computer 2, stored on the database 1a, can be updated. After the agent has compared both lists, it deletes again the list produced the previous day and stores the current list 20 to the memory assigned to the agent.

The list disclosed in FIG. 2 includes, in the case of the present example of execution, particular data about the computer, name of the computer 2, its IP-address, CPU type, number of CPUs, clock frequency of the CPU, storage capacity, etc. . . .

In case of the present example of execution, an inquiry for the current software and hardware configuration can be manually initiated with each of the computers 2 to 6. To do this, an operator 7 can for example call a screen mask 30 (FIG. 3) with the NMS1. The screen mask 30 includes icons 32-36, which represent the computers 2-6 of the network. In the current embodiment, the icon 32 represents the computer 2, the icon 33 the computer 3, the icon 34 the computer 4, the icon 35 the computer 5, and the icon 36 the computer 6. If a technician would like to now verify the current software and hardware configuration of computer 4, which controls the x-ray device 4a and is stored in database 1a, the technician mouse clicks on icon 34. Following this, the manager stored in the NMS1, transmits the inquiry for the current software and hardware configuration to the agents of the computer 4. After the agent of computer 4 has received the inquiry, it determines the current software and hardware configuration of the computer 4. Herein, the software and hardware configuration also includes data about the configuration of the x-ray device 4a, particularly data about installed components of the x-ray device 4a.

After the agent of the computer 4 has determined the current software and hardware configuration of the computer 4, it compares this with the earlier determined software and hardware configuration which the agent had determined based on the earlier inquiry from the manager. If the current determined software and hardware configuration does not differ from the earlier determined software and hardware configuration, the agent stored in the computer 4 does not transmit the current determined software and hardware configuration of the computer 4, because an image of the current software and hardware configuration of the computer 4 is already stored. Additionally, the agent of the computer 4 stores again the data about the current software and hardware configuration of the computer 4 in a memory assigned to the agent.

If a computing program used for the control of the x-ray device 4a was modified on computer 4 after the earlier inquiry, the current determined software configuration of computer 4 would therefore differ from the earlier determined software configuration. Should this be the case, the agent of computer 4 sends the manager of the NMS1 data about the modified software configuration of the computer 4, so that the data about the software and hardware configuration of the computer 4 can be updated. Furthermore, the agent of the computer 4 stores again the data about the current software and hardware configuration of the computer 4 in a memory assigned to the agent.

The invention being thus described, it will be obvious that the same may be varied in many ways. Such variations may include a mixing of elements from the above embodiments. Such variations are not to be regarded as a departure from the spirit and scope of the invention, and all such modifications as would be obvious to one skilled in the art are intended to be included within the scope of the following claims.

We claim:

1. A method for updating a database in which data about a configuration of at least one device of a network is stored, comprising the steps of:
transmitting from a database to said device an inquiry regarding a current device configuration;
determining at said device said current device configuration;
verifying at said device if said current configuration was modified since an earlier transmitted inquiry from said database; and
if said configuration has been modified, transmitting said current device configuration to said database.

2. The method according to claim 1, wherein said step of verifying further comprises the steps of:
producing a first list based on said earlier transmitted inquiry, said first list comprising data about an earlier configuration of said device;
producing a second list based on said inquiry, said second list comprising data about said current device configuration;
comparing said first list with said second list; and
transmitting said second list to said database if said data about an earlier configuration of said device and said data about said current device configuration differ.

3. The method according to claim 1, wherein said step of transmitting from a database is performed regularly.

4. The method according to claim 2, wherein said step of transmitting from a database is performed regularly.

5. The method according claim 1, wherein said steps are performed by a network management system.

6. The method according claim 2, wherein said steps are performed by a network management system.

7. The method according claim 3, wherein said steps are performed by a network management system.

8. The method according to claim 1, wherein said configuration comprises a software configuration.

9. The method according to claim 2, wherein said configuration comprises a software configuration.

10. The method according to claim 3, wherein said configuration comprises a software configuration.

11. The method according to claim 5, wherein said configuration comprises a software configuration.

12. The method according to claim 1, wherein said configuration comprises a network configuration.

13. The method according to claim 2, wherein said configuration comprises a network configuration.

14. The method according to claim 3, wherein said configuration comprises a network configuration.

15. The method according to claim 5, wherein said configuration comprises a network configuration.

16. The method according to claim 8, wherein said configuration comprises a network configuration.

17. The method according to claim 1, wherein said device comprises at least one networked computer.

18. The method according to claim 2, wherein said device comprises at least one networked computer.

19. The method according to claim 3, wherein said device comprises at least one networked computer.

20. The method according to claim 5, wherein said device comprises at least one networked computer.

21. The method according to claim 8, wherein said device comprises at least one networked computer.

22. The method according to claim 12, wherein said device comprises at least one networked computer.
